(19) United States
(12) Patent Application Publication
(10) Pub. No.: US 2016/0274305 A1
(43) Pub. Date: Sep. 22, 2016

(54) Optical Transmitter and Method of Transmitting an Optical Signal

(71) Applicant: SOURCE PHOTONICS (CHENGDU) CO., LTD., Chengdu, Sichuan (CN)

(72) Inventors: Leo YE, West Hills, CA (US); Mark HEIMBUCH, West Hills, CA (US); Shengzhong ZHANG, West Hills, CA (US)

(73) Assignee: Source Photonics (Chengdu) Co., Ltd., Chengdu (CN)

(21) Appl. No.: 14/523,602

(22) PCT Filed: Oct. 14, 2014
(86) PCT No.: PCT/CN2014/088591

§ 371 Date: Oct. 24, 2014

(51) Int. Cl. G02B 6/27; G02B 5/30; H04B 10/50; G02B 6/32; H04B 10/58; G02F 1/09; G02B 27/28

(52) U.S. Cl. CPC G02B 6/2746; G02F 1/093; G02B 5/3083; G02B 27/286; G02B 6/2706; G02B 6/32; H04B 10/58; H04B 10/503

(57) ABSTRACT

An optical or free space isolator, and optical or optoelectronic transmitter and methods of transmitting an optical signal and making the transmitter are disclosed. The optical/free space isolator includes a first polarizer, configured to polarize light at a first polarization angle and block light at a second polarization angle; a Faraday rotator, configured to rotate the light polarized by the first polarizer by a predetermined number of degrees; and a half waveplate in the optical/light path, having a fixed or predetermined orientation angle. The first polarizer, Faraday rotator/isolator, and half waveplate have respective polarization, rotation and orientation values that allow light to pass through the optical isolator in a first direction, and block reflected light traveling through the optical isolator along a direction opposite to the first direction.

### FIELD OF THE INVENTION

The present invention generally relates to the field of optical and/or free space isolators, and optical and optoelectronic devices containing the same.

### DISCUSSION OF THE BACKGROUND

Optical transmitters are devices that send optical signals over optical signal transmission media in optical and optoelectronic networks. Typically, an optical transmitter is included with an optical receiver in an optical transceiver. Recently, multi-channel optical transceivers have been made to communicate multiple signals over a single transmission medium.

Multiple wavelength division multiplexing (WDM) has been used for optical interfaces for data rates at 40 Gbps (e.g., 40 GBASE LR4 and ER4) and 100 Gbps (e.g., 100 GBASE LR4 and ER4). The IEEE 802.3ba-2010 standard defines four WDM channels multiplexed onto a single fiber for these interfaces. The 40 GBASE-LR4/ER4 interface defines CWDM grids with center wavelengths of 1271, 1291, 1311, and 1331 nm. The 100GBASE-LR4/ER4 interface defines LAN-WDM channels with center wavelengths of 1295.56, 1300.05, 1304.58, and 1309.14 nm.

Furthermore, free space isolators (FSI) are an important component to protect a laser from being damaged by reflected light. Free space isolators can eliminate or minimize the effects of reflected light to optimize light that is transmitted in one direction. Reflected light may also interfere with light emitted from a laser. As a result, there is a demand to eliminate the effects of reflected light within transmitters and transceivers.

This “Discussion of the Background” section is provided for background information only. The statements in this “Discussion of the Background” are not an admission that the subject matter disclosed in this “Discussion of the Background” section constitutes prior art to the present disclosure, and no part of this “Discussion of the Background” section may be used as an admission that any part of this application, including this “Discussion of the Background” section, constitutes prior art to the present disclosure.

### SUMMARY OF THE INVENTION

Embodiments of the present invention relate to an optical or free space isolator, an optical or optoelectronic transmitter (e.g., configured to transmit collimated or polarized light or light signals), a multichannel optical or optoelectronic transmitter, and methods for transmitting a (polarized) optical signal in such an optical or optoelectronic transmitter (e.g., an optical signal transmitter or transceiver, such as a transceiver for a fiber optic network). The present invention provides an isolator that advantageously changes the polarization direction of reflected light relative to the polarization direction of emitted light, thereby eliminating interference between the emitted light and the reflected light, and protecting the laser from damage by the reflected light. As a result, the emitted light maintains its strength and/or intensity, and any interference between reflected and emitted light is relatively small.

In one aspect, the comprising a first polarizer, a Faraday rotator, a second polarizer in a light path passing through the first polarizer and the Faraday rotator, on a side of or surface of the Faraday rotator opposite from the first polarizer, and a half waveplate in the light path, having a fixed or predetermined orientation angle ε. The first polarizer is configured to polarize light at a first polarization angle α and block light at a second polarization angle β. The Faraday rotator is configured to rotate the light polarized by the first polarizer by δ degrees, where δ is a predetermined number. The second polarizer is configured to polarize light at a third polarization angle γ. The angles α, δ and ε have values that allow light to pass through the optical isolator in a first direction, and block reflected light traveling through the optical isolator along a second direction opposite to the first direction.

In various embodiments, the second polarization angle β is orthogonal to the first polarization angle α. For example, light passing through or emerging from the optical isolator in the first direction has a polarization angle that is orthogonal to the first polarization angle α. In such embodiments, δ+[2*(ε−[α+δ]) is about (2n+1)*90°, and n is an integer. In an idealized case, δ is about ±(β−α)/2, and ε is about [(β−α)−δ]/4. Alternatively, light passing through the optical isolator in the first direction has a polarization angle that is parallel to (e.g., the same as or 180° different from) the first polarization angle α. In such embodiments, δ+[2*(ε−[α+δ]) is about q*180°, and q is an integer.

In another aspect, the present invention relates to an optical or optoelectronic transmitter, comprising a light emitter on an optical board, one or more lenses in an optical path of the light, the present optical or free space isolator in the optical path of the light, and an optical medium receiving the light beam or signal polarized by the optical or free space isolator. The optical or free space isolator is in the optical path of the light from the light emitter, and provides a polarized light beam or signal having a predetermined polarization angle.

Embodiments of the present transmitter include an optical subassembly comprising a first optical component configured to focus or reflect light from the light emitter, a second optical component configured to reflect or filter light from the light emitter, and/or a structural support on which the first optical component, the optical/free space isolator, and optionally the second optical component are deposited, fixed or mounted. In some embodiments, the first optical component may comprise a first lens, and the transmitter may further comprise a second lens. In such embodiments, the first lens is adjacent to the light emitter, and the second lens is adjacent to the optical medium. In further embodiments, the optical medium comprises an optical fiber. The optical fiber may be received in and secured by a coupler or connector in the housing of the transmitter.

In the present transmitter, light may be reflected by the second lens and/or the optical medium. The optical or free space isolator is configured to pass light from the light emitter to the optical medium, and block the light reflected by the optical medium and/or the second lens. Reflected light (e.g., that travels in the second or reverse direction) is further rotated by the Faraday rotator, and is then effectively filtered by the first polarizer.

In another aspect, the present invention relates to a multichannel optical or optoelectronic transmitter, comprising a plurality of light emitters on an optical board, one or more lenses in an optical path of the light emitted by each light emitter, an optical or free space isolator in the optical path of the light from each light emitter and providing a polarized light beam or signal having a predetermined polarization angle, and an optical medium in the optical path of the polarized light beam or signal, receiving the polarized light beam or signal from the optical or free space isolator. Each light emitter is configured to emit light having a unique and/or characteristic wavelength and/or a predetermined polarization type. The optical or free space isolator comprises a Faraday rotator, first and second polarizers on opposite sides of the Faraday rotator along the optical path, and a half waveplate in the optical path having a fixed or predetermined orientation angle. The first polarizer is configured to polarize light at a polarization angle and block light at a second polarization angle. The Faraday rotator is configured to rotate light polarized by the first polarizer by a predetermined number of degrees.

Various embodiments of the multichannel optical or optoelectronic transmitter further comprise an optical subassembly, comprising a first optical component configured to focus or reflect light from a first one of the light emitters, a second optical component configured to focus or reflect light from a second one of the light emitters, a third optical component configured to combine light from at least two of the light emitters, and one or more structural supports on which the first, second and third optical components and the optical or free space isolator are deposited, fixed or mounted. In some embodiments, the third optical component comprises a dichroic mirror or polarization filter. In further embodiments of the multichannel optical or optoelectronic transmitter, the plurality of light emitters comprises first through fourth light emitters, and the transmitter further comprises fourth and fifth optical components, each configured to reflect and/or combine light from the third and fourth light emitters. Additionally or alternatively, the first optical component comprises a first lens configured to focus light from the first light emitter, and the second optical component comprises a first mirror configured to reflect light from the second light emitter. Further embodiments of the multichannel optical or optoelectronic transmitter further comprise second through fourth lenses, configured to focus light from the second through fourth light emitters, respectively.

A further aspect of the present invention relates to a method of transmitting a polarized optical signal, comprising emitting light from a light emitter, passing the light through an optical or free space isolator in a first direction to provide the polarized optical signal, and blocking any light reflected back on the optical or free space isolator along a direction opposite to the first direction. The optical or free space isolator comprises a Faraday rotator, first and second polarizers on opposite sides of the Faraday rotator along the optical path, and a half waveplate in the optical path. The first polarizer is configured to polarize light at a first polarization angle and block light at a second polarization angle. The Faraday rotator is configured to rotate polarized light by a predetermined number of degrees. The half waveplate has a fixed or predetermined orientation angle.

Further embodiments of the present method may comprise passing the light through a first lens before passing the light through the optical or free space isolator, passing the polarized light through a second lens after passing the light through the optical or free space isolator, directing or focusing the polarized light onto an optical medium, and/or applying a magnetic field to the Faraday isolator. One of the lenses may direct or focus the polarized light onto the optical medium.

The present optical or free space isolator, single channel or multichannel optical or optoelectronic transmitter, and method of transmitting a polarized optical signal advantageously change the polarization direction of reflected light relative to the polarization direction of emitted light, reducing interference between emitted and reflected light, and protecting the laser(s) from damage. In some cases, the polarization direction of the reflected light is perpendicular to the polarization direction of the emitted light. By reducing interference between emitted and reflected light, the present invention enables stronger or more coherent light to pass to the transmission medium. These and other advantages of the present invention will become readily apparent from the detailed description of exemplary embodiments below.

### BRIEF DESCRIPTION OF THE DRAWINGS

FIG. 1 is a block diagram of an exemplary single-channel device (e.g., transmitter) according to the present invention.

FIGS. 2A-D are diagrams showing exemplary embodiments of an optical or free space isolator in accordance with the present invention.

FIG. 3A is a diagram showing an exemplary manner of operation of the exemplary optical or free space isolator(s) during transmission of an optical signal in accordance with embodiments of the present invention.

FIG. 3B is a diagram showing an exemplary manner of operation of the exemplary optical or free space isolator(s) with regard to a reflected optical signal in accordance with embodiments of the present invention.

FIG. 4 is a diagram showing an exemplary optoelectronic transmitter (e.g., a transmitter optical sub-assembly or TOSA) in a sealed housing fitted with a connector for receiving an optical fiber.

FIG. 5 is a flow chart showing an exemplary method of making an optical or optoelectronic transmitter configured to transmit a polarized signal in accordance with embodiments of the present invention.

### DETAILED DESCRIPTION

Reference will now be made in detail to various embodiments of the invention, examples of which are illustrated in the accompanying drawings. While the invention will be described in conjunction with the following embodiments, it will be understood that the descriptions are not intended to limit the invention to these embodiments. On the contrary, the invention is intended to cover alternatives, modifications and equivalents that may be included within the spirit and scope of the invention. Furthermore, in the following description of the present invention, numerous specific details are set forth in order to provide a thorough understanding of the present invention. However, it will be readily apparent to one skilled in the art that the present invention may be practiced without these specific details. In other instances, well-known methods, procedures, components, and circuits have not been described in detail so as not to unnecessarily obscure aspects of the disclosure.

Unless specifically stated otherwise, or as will be apparent from the following discussions, it is appreciated that throughout the present application, discussions utilizing terms such as “processing,” “operating,” “calculating,” “determining.” or the like, refer to the action and processes of a computer, data processing system, or similar processing device (e.g., an electrical, optical, or quantum computing or processing device or circuit) that manipulates and transforms data represented as physical (e.g., electronic) quantities. The terms refer to actions and processes of the processing devices that manipulate or transform physical quantities within the component(s) of a circuit, system or architecture (e.g., registers, memories, other such information storage, transmission or display devices, etc.) into other data or information similarly represented as physical quantities within other components of the same or a different system or architecture.

Furthermore, in the context of this application, the terms “signal” and “optical signal” refer to any known structure, construction, arrangement, technique, method and/or process for physically transferring a signal or optical signal, respectively, from one point to another. In addition, the terms “known.” “fixed,” “given,” “certain” and “predetermined” generally refer to a value, quantity, parameter, constraint, condition, state, process, procedure, method, practice, or combination thereof that is, in theory, variable, but is typically set in advance and not varied thereafter when in use. Also, the terms “optical” and “optoelectronic” are generally used interchangeably herein, and use of either of these terms also includes the other, unless the context clearly indicates otherwise. Furthermore, the terms “Faraday rotator” and “Faraday isolator” are generally used interchangeably herein, as are the terms “optical isolator” and “free space isolator,” and use of either of the terms in each pair also includes the other, unless the context clearly indicates otherwise. Similarly, for convenience and simplicity, the terms “optical device” and “optoelectronic device,” as well as the terms “transmitter,” “transceiver.” “optical transmitter” and “optical transceiver,” may be used interchangeably unless the context clearly indicates otherwise, but these terms are generally given their art-recognized meanings herein. The term “transceiver” generally refers to a device having at least one receiver and at least one transmitter. Furthermore, the terms “placing,” “securing,” “affixing,” “adhering.” “mounting” and “attaching” are generally used interchangeably herein, and use of one such term generally includes the others, but these terms are generally given their art-recognized meanings.

Embodiments of the present invention advantageously provide an apparatus and method of transmitting a polarized optical signal or beam that protects a laser from reflected light. Various embodiments and/or examples disclosed herein may be combined with other embodiments and/or examples, as long as such a combination is not explicitly disclosed herein as being unfavorable, undesirable or disadvantageous. The invention, in its various aspects, will be explained in greater detail below with regard to exemplary embodiments.

Exemplary Optical or Optoelectronic Transmitters

In general, components in an optical or optoelectronic device (e.g., a single or a multi-channel optical transmitter or transceiver) transmit optical signal(s). Each optical signal transmitted in an optical path may have a unique center wavelength corresponding to a channel of a single-channel or multichannel optical communication system or network. In general, the center wavelength of each optical signal may differ from other center wavelengths by about 4.5 nm or more. The various channels can be distinguished from each other by wavelength (e.g., a difference of at least 20 Å, 40 Å, 80 Å, 4 nm, 20 nm, etc.), frequency (e.g., a difference of at least 5 Hz, 10 Hz, 20 Hz, 50 Hz, etc.), data transmission rate, or a combination thereof. Also, each optical signal in a single- or multi-channel optical or optoelectronic transmitter may have one of a plurality of polarization types (e.g., s-polarization or p-polarization).

Embodiments of the present invention relate to an optical or optoelectronic transmitter (e.g., in a 40G or 100G-compliant transceiver), comprising a light emitter on an optical board, configured to emit light; one or more lenses in an optical path of the light; an optical or free space isolator in the optical path of the light, providing a polarized light beam or signal having a predetermined polarization angle, and an optical medium in the optical path of the polarized light beam or signal, receiving the polarized light beam or signal from the optical or free space isolator. The optical or free space isolator comprises a first polarizer, a Faraday rotator, a second polarizer, and a half waveplate. The first polarizer is configured to polarize light at a first polarization angle and block light at a second polarization angle (e.g., substantially different from or orthogonal to the first polarization angle). The Faraday rotator is configured to rotate the light polarized by the first polarizer by a predetermined number of degrees. The second polarizer is in an optical (or light) path passing through the first polarizer and the Faraday rotator, and on a side of or surface of the Faraday rotator opposite from the first polarizer. The second polarizer is configured to polarize light at a third polarization angle. The half waveplate is in the optical or light path, and has a fixed or predetermined orientation angle. The polarization, rotation and orientation angles of the first polarizer, Faraday rotator, and half waveplate have values that allow light to pass through the optical isolator in a first direction, and block reflected light traveling through the optical isolator along an opposite (e.g., reflected) direction. The free space isolator rotates the polarization direction of reflected light (e.g., from the optical medium) by an amount that the first polarizer blocks, thereby reducing interference between the emitted light and the reflected light, and protecting the light emitter from damage.

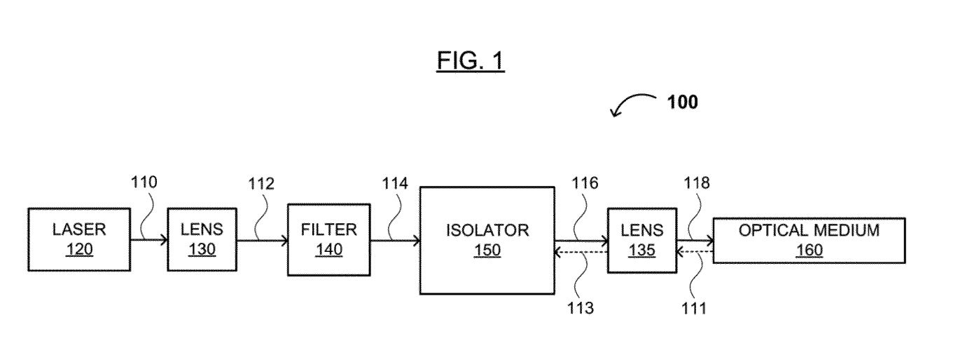

FIG. 1 shows a block diagram of an exemplary single-channel device (e.g., transceiver) 100. The present device 100 includes a light emitter (e.g., a laser) 120, a first lens 130, a filter 140, a Faraday isolator 150, a second lens 135, and an optical medium 160. The light emitter 120 may include a laser diode and/or light-emitting diode (LED). In the exemplary single-channel device 100, a light emitter 120 that emits polarized light or light pulses may be used (e.g., a pulsed edge- or surface-emitting laser diode, a distributed feedback laser [DFB], an electro-modulated laser [EML], etc.), although a light emitter that produces non-polarized or non-coherent light may also be used, in conjunction with a polarizer in the optical path of the light emitted by the light emitter. The light signal 110 from the laser 120 may be pulsed at a rate of 1 kHz to 25 GHz, or any value or range of values therein. The light signal 110 emitted by the laser 120 may have a first polarization type or a second polarization type (e.g., s-polarization or p-polarization). The single-channel device 100 of FIG. 1 may also emit collimated light, and thus further comprise a collimator or waveguide (not shown).

The first lens 130 focuses and/or polarizes the light signal 110 from the light emitter 120 onto the second lens 135. The first lens 130 thus passes a focused and/or polarized light signal 112 to the filter 140. The first lens 130 may be pre-assembled or pre-adhered to a corresponding lens holder (not shown).

The filter (or beam splitter) 140 may be or comprise a wavelength-selective filter (e.g., a light filter that selectively allows light 113 of a certain wavelength or wavelength range to pass through, while other wavelengths are reflected, absorbed or scattered, as the case may be). For example, the filter 140 may include a dichroic mirror that reflects light having a relatively long wavelength, while passing through light having a relatively short wavelength. Alternatively, the filter 140 may reflect light having a relatively short wavelength, while passing through light having a relatively long wavelength. In a further alternative, the filter 140 may reflect light having a first polarization type, while passing through light having a second polarization type. Thus, the filter 140 may be or comprise a polarization filter or beam splitter. In general, the filter 140 blocks light having a wavelength and/or polarization type other than that of the light signal 113, depending on the wavelength and/or polarization type of the channel.

The optical isolator or free space isolator 150 is in the optical path of the (polarized) light emitted from the light emitter 120, and may include optical components that, in combination, allow transmission of light 114 in only one direction. The optical/free space isolator 150 has a first surface receiving light signal 113 traveling in a first direction, and a second surface receiving reflected light 113 traveling in a second (e.g., opposite) direction. The optical/free space isolator 150 produces polarized light 116 having a predetermined polarization angle. Consistent with known Faraday rotators, the optical/free space isolator 50 may further comprise one or more (generally a plurality) of electromagnetic plates configured to apply a substantially uniform magnetic field (e.g., flux density) across the region of a Faraday rotator in the optical/free space isolator 150 through which the light signal 114 and reflected light 113 pass. The optical/free space isolator 150 may also comprise one or more antireflective coatings on the first and/or second surfaces, or alternatively, on one or more surfaces of a component of the optical/free space isolator 150.

The second lens 135 may be similar to the first lens 130, and focuses polarized light signal 116 from the optical/free space isolator 150 onto an end of the optical medium 160 or another focal point in the optical medium 160. Subsequently, focused, polarized light 118 is transmitted through the optical medium (e.g., an optic fiber) 160 to other devices in the optical network. However, some of the light 118 (usually on the order of 5% or less) is reflected by optical medium 160. Also, some of the light 116 (usually on the order of 2% or less) may also be reflected by the second lens 135 (e.g., as a component of the reflected light 113). The reflected light 113 is rotated a predetermined number of degrees (e.g., 450) by the optical/free space isolator 150, in the same direction as the filtered light 114. As a result, the reflected light rotated by the optical/free space isolator 150 has a polarization direction that is substantially different from (e.g., perpendicular to) the polarization angle of a first polarizer (not shown in FIG. 1) in the optical/free space isolator 150. The first polarizer thus effectively filters the reflected polarized light 111 and/or 113. Thus, the exemplary single-channel device 100 of FIG. 1 may reduce or eliminate damage to the laser 120 by reflected light.

Exemplary Optical or Free Space Isolators

As mentioned above, the present invention relates in part to an optical or free space isolator that comprises a first polarizer, a Faraday rotator, a second polarizer, and a half waveplate. The first polarizer is configured to polarize light at a first polarization angle α and block light at a second polarization angle β. The Faraday rotator is configured to rotate the light polarized by the first polarizer by δ degrees, where δ is a predetermined number. The second polarizer is in an optical (or light) path passing through the first polarizer and the Faraday rotator, and on a side of or surface of the Faraday rotator opposite from the first polarizer. The second polarizer is configured to polarize light at a third polarization angle γ. The half waveplate is in the optical or light path, and has a fixed or predetermined orientation angle ε. The angles α, δ and ε have values that allow light to pass through the optical isolator in a first direction, and block reflected light traveling through the optical isolator along a second direction opposite to the first direction. Given that some reflected light may not travel in a path precisely 180° different from the first direction (e.g., it may be reflected at an angle other than 180°), the second direction is considered opposite to the first direction as long as it can be defined as having a vector component that is 180° different from the first direction.

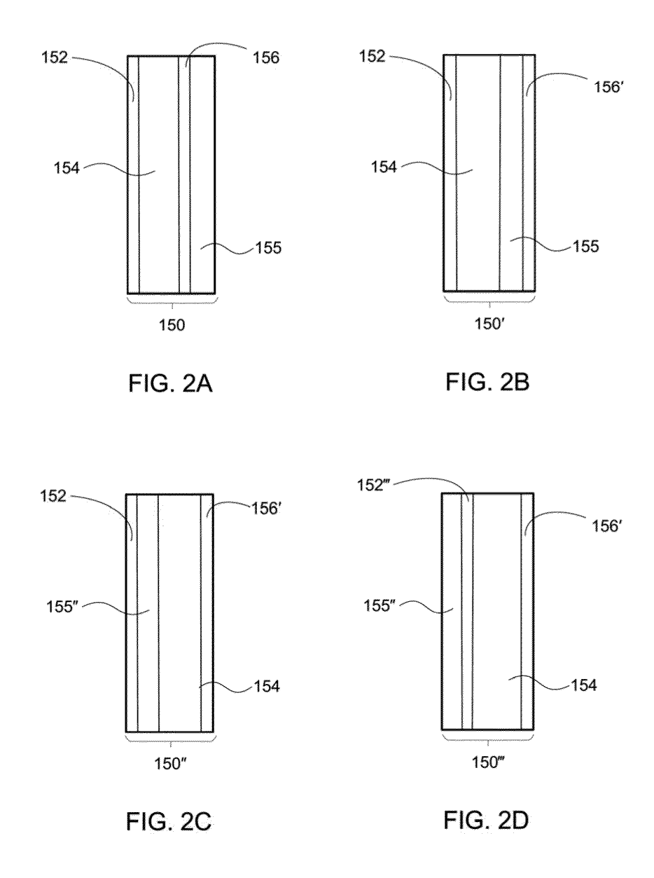

FIGS. 2A-D show diagrams of exemplary embodiments of optical or free space isolators 150-150□. In general, the exemplary optical or free space isolators 150-150□ comprise a first polarizer 152, a Faraday rotator 154, a half waveplate 155, and a second polarizer 156. As long as the first and second polarizers 152 and 156 are on opposite sides of the Faraday rotator 154 along the optical path through the optical or free space isolator, the half waveplate 155 can be located anywhere along the optical path.

Referring to FIG. 2A, the first polarizer 152 is on a first surface of the Faraday rotator 154, and is configured to receive light from the light emitter (e.g., laser; not shown in FIG. 2A). The first polarizer 152 polarizes the light from the light emitter at a first polarization angle α. The first polarization angle α can have any value, but for convenience (e.g., compatibility with standard optical networks), it may be a multiple of 45° (e.g., 0°, 45°, 90°, 135°, etc.).

The Faraday rotator 154 is conventional, and is configured to rotate the polarized light from the first polarizer 152 by a preset or predetermined number of degrees δ. Thus, each of the optical or free space isolators 150-150□ are accompanied by first and second magnetic or electromagnetic plates (not shown in FIGS. 2A-D). The preset or predetermined number of degrees δ can be any value that enables the light passing through the optical or free space isolator 150 to comply with requirements of the (corresponding) optical network channel, and reflected light passing through the Faraday rotator 154 in the reverse direction to be blocked or filtered by the first polarizer 152. However, consistent with known characteristics of Faraday rotators, the polarization angle of light passing through the Faraday rotator 154 in either direction is rotated in the same direction (e.g., +45° or −45°, depending on the orientation of the magnetic field generated by the magnetic or electromagnetic plates). Thus, is certain embodiments, δ is (2r+1)*45°, where r is an integer. For convenience, r may be 0 or −1.

The second polarizer 156 is on a second surface of the Faraday rotator 154 opposite from the first surface/first polarizer 152, and is configured to receive light from the Faraday rotator 154. The second polarizer 156 polarizes the light from the light emitter at a third polarization angle γ. Generally, the third polarization angle γ matches the polarization angle of the light from the Faraday rotator 154. The third polarization angle γ can have any value, but for convenience (e.g., compatibility with standard optical networks), in the embodiment of FIG. 2A, it may be a multiple of 45° (e.g., 0°, 45°, 90°, 135°, etc.).

The half waveplate 155 is generally conventional, and rotates the light from the second polarizer 156 by two times the difference between the third polarization angle γ of the light from the second polarizer 156 and the orientation angle ε of the half waveplate 155. The orientation angle ε of the half waveplate 155 can have substantially any value, as long as the light emerging from the optical or free space isolator 150 is substantially orthogonal (i.e., different by [2n+1]*90°, where n is an integer, such as −1, 0, 1, etc.) or, in some embodiments, parallel (i.e., different by 2m*180°, where m is an integer, such as −1, 0, 1, etc.) to the first polarization angle α.

Examples of various polarization, rotation and orientation angles α, γ, δ, and ε for the first polarizer 152, Faraday rotator 154, half waveplate 155, and second polarizer 156 in the optical or free space isolator 150 are shown in Table 1 below (“Pₒᵤₜ” refers to the polarization angle of light from the laser 120 [FIG. 1] after passing through the optical isolator 150):

TABLE 1
Examples of polarization, rotation and
orientation angles α, γ, δ, and ε in the optical
or free space isolator 150 (FIG. 2A).

| Example | α | δ | γ | ε | Pₒᵤₜ |
|---|---|---|---|---|---|
| 1 | 0 | 45 | 45 | 67.5 | 90 |
| 2 | 0 | 45 | 45 | 22.5 | 0 |
| 3 | 90 | −45 | 45 | 67.5 | 90 |
| 4 | 90 | −45 | 45 | 22.5 | 0 |
| 5 | 45 | 45 | 90 | 112.5 | 135 |
| 6 | 45 | −45 | 0 | 67.5 | 135 |
| 7 | 0 | 60 | 60 | 75 | 90 |
| 8 | 0 | 30 | 30 | 60 | 90 |
| 9 | 0 | 22.5 | 22.5 | 56.25 | 90 |
| 10 | 0 | 60 | 60 | 165 | 270 |
| 11 | 0 | 135 | 135 | 202.5 | 270 |

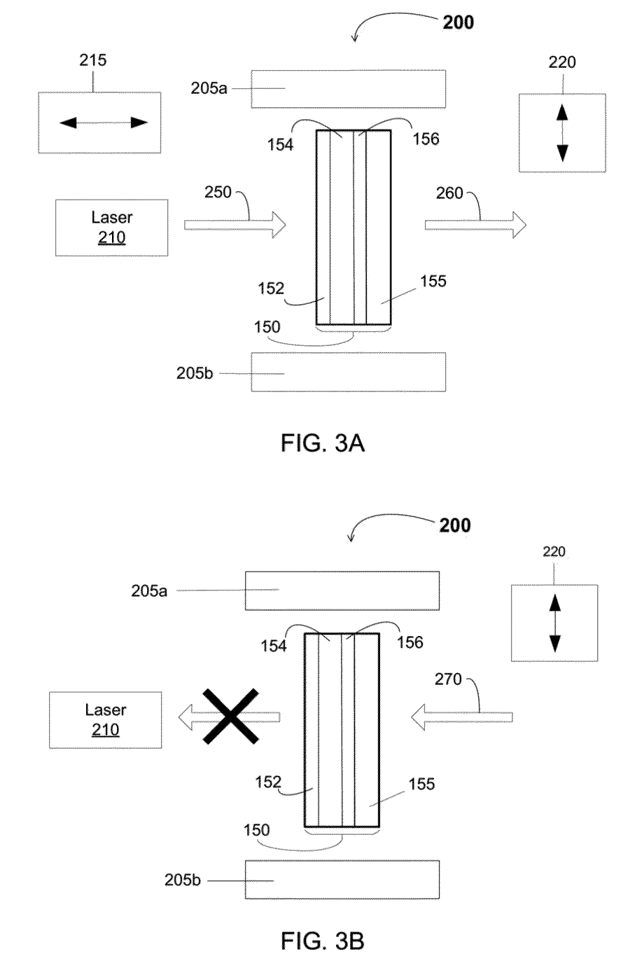

The operation of the various components in an optical or optoelectronic device (e.g., an optical transmitter or transceiver) will be explained below with reference to exemplary methods of transmitting an optical signal and FIGS. 3A-B.

Exemplary Methods of Transmitting an Optical Signal in a Single-Channel Optical or Optoelectronic Transmitter

In general, components in a single- or multi-channel optical or optoelectronic device (e.g., an optical transmitter or transceiver) transmit an optical signal. Each optical signal in an optical path may have a unique center wavelength corresponding to a channel of a (multichannel) optical communication system or network.

FIG. 3A shows an exemplary manner of operation of the optical isolator 150 in transmission of an optical signal in accordance with embodiments of the present invention. For simplicity of explanation, FIGS. 3A-B will be explained with reference to the Faraday isolator 150 (FIG. 2A), but the method is also applicable to the optical or free space isolators 150′-150□ of FIGS. 2B-D (discussed below).

The exemplary method of transmitting an optical signal may comprise emitting light 250 from a light emitter (e.g., laser) 210, and passing the light through the optical isolator 150, including the first polarizer 152, the Faraday rotator 154, the second polarizer 156, and the half waveplate 155. The light 250 emitted from the laser 210 may be polarized prior to passing through the Faraday isolator 150, but it is not necessary to do so. In one example, however, the light 250 has a polarization angle 215 of 0° (see, e.g., Examples 1-2 and 7-11 in Table 1 above).

The first polarizer 152 polarizes the light 250 at the first polarization angle α, or alternatively, when the light 250 is already polarized at the polarization angle 215, the first polarizer 152 ensures that the light entering the optical isolator 150 has the first polarization angle α before passing through the Faraday rotator 154. The Faraday rotator 154 then rotates the polarization direction of the light 250 by a predetermined number of degrees δ. As shown in Examples 1-6 and 11 in Table 1 above, δ can be (2r+1)*45°, where r is an integer. A magnetic field may be applied to the Faraday rotator 154 by opposed magnetic or electromagnetic plates 205a-b.

The polarized light then passes through the second polarizer 156 at the same polarization angle provided by the Faraday rotator 154. The half waveplate 155 then rotates the polarization angle of the polarized light from the second polarizer 156 by twice the difference between the orientation angle ε of the half waveplate 155 and the polarization angle γ of the second polarizer 156. For example, in Example 1 of Table 1 above, ε is 67.5°, and γ is 45°. As a result, the light 260 emerging from the optical isolator 150 has a polarization angle 220 of 45°+(2*[67.5°−45°])=90°, which is orthogonal to the polarization angle 215 of the light 250 from the laser 210 or first polarizer 152. In Example 2, ε is 22.5°, and γ is 45°, and the light 260 emerging from the optical isolator 150 has a polarization angle 220 of 45°+(2*[22.5°−45°])=0°, which is not orthogonal to the polarization angle 215, but is a standard polarization angle for optical signals in optical networks. Examples 3-12 in Table 1 give substantially the same results (Examples 4-11 provide orthogonally polarized output signals), using different combinations of polarization, rotation and orientation angles α, γ, δ, and ε. As will be shown, it is not necessary for the output signal 260 to have a polarization angle 220 that is orthogonal to the polarization angle 215 of the emitted signal 250.

In many embodiments, the present method may include passing the (polarized) light 250 through a first lens (e.g., to focus the light on a particular or predetermined target) before and/or after passing the (polarized) light 250 through the optical isolator 150. The lens through which the polarized light passes after the optical isolator 150 may direct or focus the polarized light 260 onto the optical medium.

Polarized light 260 (FIG. 3A) may be reflected by the optical medium (not shown) and/or a second lens (not shown) between the optical medium and the optical isolator 150. FIG. 3B shows an exemplary method of rotating the polarization direction of light reflected from an optical signal, and thus blocking or filtering the reflected light, in accordance with embodiments of the present invention. The reflected light 270 incident on the half waveplate 156 rotates by twice the difference between the orientation angle ε of the half waveplate 155 and the polarization angle of the reflected light 270, which may be presumed to have the same polarization angle 220 as the output signal 260. In Example 1 of Table 1 above, ε is 67.5°, and the polarization angle of the reflected light 270 is 90°. As a result, the light has a polarization angle of 90+(2*[90°−67.50°])=45π after passing through the half waveplate 156.

The Faraday rotator 154 then rotates the light from the half waveplate 155 by the predetermined number of degrees 6 in the same rotational direction (e.g., +45°) as it rotated the light 250 from the laser 210. Thus, in Example 1 above, after passing through the half waveplate 155, the polarization angle of the light rotates another 45° through the Faraday rotator 154 to 90°. The first polarizer 152 polarizes light at a first polarization angle α, but blocks light having a second polarization angle β. Ideally, a polarizer blocks light that has a polarization angle that is orthogonal to the polarization angle of the polarizer. As a result, in Example 1, the first polarizer 152 blocks the reflected light 270, which has a polarization angle of 90° when it reaches the first polarizer 152. Therefore, the reflected light 270 does not interfere with polarized light emitted by the laser 210, nor does the reflected light 270 cause damage to the laser 210 (or a cavity thereof). The optical isolator 150 thus outputs polarized light at a polarization angle suitable for transmission in an optical network, but blocks reflected light. As a result, the optical isolator 150 reduces interference with transmitted light, and provides a more stable laser.

Other examples from Table 1 above provide the same results. For instance, in Example 2, the reflected light 270 has a polarization angle of 0°. It is rotated to 45° by the half waveplate 155 (where it passes through the second polarizer 156), and an additional 45° by the Faraday rotator 155 to 90°, where it is blocked by the first polarizer 152, having a first polarization angle α of 0°. Examples 3-4 show that the same results can be obtained for optical isolators 150 having a first polarizer 152 with a first polarization angle α of 90°, and Examples 5-6 show that the same results can be obtained for optical isolators 150 having a first polarizer 152 with a first polarization angle α of 45° (45° and 135° also being standard polarization angles for transmission of optical signals over an optical network). In Examples 7-10, the polarization angle β of the reflected light 270 after passing through the Faraday rotator 154 is not orthogonal to the polarization angle α of the first polarizer 152, but even when the difference β−α is not (2n+1)*90°, some attenuation of the reflected light 270 occurs as long as the difference β−α is not m*180°, or close thereto. Example 11 shows that the invention works even when the values of polarization, rotation and orientation angles γ, δ, and ε are relatively large.

Additional Exemplary Optical or Free Space Isolators

FIGS. 2B-2D show additional examples of optical isolators 150′-150□ that are suitable for use in the present invention. FIG. 2B shows an optical isolator 150′ that includes first polarizer 152. Faraday rotator 154, half waveplate 155, and a second polarizer 156′. The structure and function of each component of the optical isolator 150′ is generally the same or substantially the same as described with regard to optical isolator 150 in FIG. 2A. However, there is a difference in the second polarizer 156′.

The structure and operation of the first polarizer 152 and the Faraday rotator 154 is the same or substantially the same as in FIG. 2A, and the structure and operation of the half waveplate 155 is the same or substantially the same as in FIG. 2A. However, the polarization angle γ of the second polarizer 156′ is equal or substantially equal to the polarization angle of the light emerging from the half waveplate 155, rather than the Faraday rotator 154. Examples of various polarization, rotation and orientation angles α, γ, δ, and ε for the first polarizer 152, Faraday rotator 154, half waveplate 155, and second polarizer 156′ in the optical or free space isolator 150′ are shown in Table 2 below:

TABLE 2
Examples of polarization, rotation and
orientation angles α, γ, δ, and ε in the optical
or free space isolator 150′ (FIG. 2B).

| Example | α | δ | ε | γ | Pₒᵤₜ |
|---|---|---|---|---|---|
| 12 | 0 | 45 | 67.5 | 90 | 90 |
| 13 | 0 | 45 | 22.5 | 0 | 0 |
| 14 | 90 | −45 | 67.5 | 90 | 90 |
| 15 | 90 | −45 | 22.5 | 0 | 0 |
| 16 | 0 | 60 | 75 | 90 | 90 |
| 17 | 0 | 30 | 60 | 90 | 90 |
| 18 | 0 | 22.5 | 56.25 | 90 | 90 |
| 19 | 45 | 45 | 112.5 | 135 | 135 |
| 20 | 45 | −45 | 67.5 | 135 | 135 |

The operation of the optical isolator 150′ is thus substantially the same as that of the optical isolator 150 of FIG. 2A. Notably, Pₒᵤₜ (the polarization angle of light after passing through the optical isolator 150′) is the same as the second polarization angle γ (which is the same as the polarization angle of the light after passing through the half waveplate 155). As for the examples of Table 1, Examples 12-15 and 19-20 lead to reflected light having a polarization angle that is orthogonal to the first polarization angle α after passing through the Faraday rotator 154. Also, in Examples 12 and 15-20, the third polarization angle γ is orthogonal (i.e., different by [2n+1]*90°, where n is an integer, such as −1, 0, 1, etc.) to the first polarization angle α. The optical isolator 150′ is effective regardless of the value of the first polarization angle α, as well as for a variety of different orientation angles ε and predetermined polarization shifts δ.

FIG. 2C shows an optical isolator 150″ that includes first polarizer 152, a half waveplate 155″, Faraday rotator 154, and second polarizer 156′. The structure and function of each component of the optical isolator 150″ is generally the same or substantially the same as described with regard to optical isolator 150′ in FIG. 2B. The optical isolator 150″ of FIG. 2C shows that the relative positions of the half waveplate 155″ and the Faraday rotator 154 with respect to the laser 120 and optical medium 160 (FIG. 1) are interchangeable, although the orientation angle of the half waveplate 155″ may differ from that of the half waveplate 155 in FIGS. 2A-2B.

The structure and operation of the first polarizer 152 and the Faraday rotator 154 is the same or substantially the same as in FIG. 2A, and the structure and operation of the second polarizer 156′ is the same or substantially the same as in FIG. 2B. However, the orientation angle δ of the half waveplate 155″ varies relative to that of the half waveplate 155 in FIGS. 2A-B. Examples of various polarization, rotation and orientation angles α, γ, δ, and ε for the first polarizer 152, Faraday rotator 154, half waveplate 155″, and second polarizer 156′ in the optical or free space isolator 150″ are shown in Table 3 below:

TABLE 3
Examples of polarization, rotation and
orientation angles α, γ, δ, and ε in the optical
or free space isolator 150″ (FIG. 2C).

| Example | α | ε | δ | Γ | Pₒᵤₜ |
|---|---|---|---|---|---|
| 21 | 0 | 22.5 | 45 | 90 | 90 |
| 22 | 0 | −22.5 | −45 | −90 | −90 |
| 23 | 90 | 67.5 | −45 | 0 | 0 |
| 24 | 90 | 112.5 | 45 | 180 | 180 |
| 25 | 0 | 15 | 60 | 90 | 90 |
| 26 | 0 | 30 | 30 | 90 | 90 |
| 27 | 0 | 60 | −30 | 90 | 90 |
| 28 | 45 | 67.5 | 45 | 135 | 135 |
| 29 | 45 | 22.5 | −45 | −45 | −45 |
| 30 | 45 | 22.5 | 45 | 45 | 45 |

The operation of the optical isolator 150″ is thus substantially the same as that of the optical isolator 150′ of FIG. 2B. Pₒᵤₜ (the polarization angle of light after passing through the optical isolator 150″) is the same as the second polarization angle γ of the second polarizer 156′ (which is the same as the polarization angle of the light after passing through the Faraday rotator 154). Examples 21-24 and 28-30 lead to reflected light having a polarization angle that is orthogonal to the first polarization angle α after passing through the Faraday rotator 154. Also, in Examples 21-29, the third polarization angle γ is orthogonal (i.e., different by [2n+1]*90°, where n is an integer, such as −1, 0, 1, etc.) to the first polarization angle α. The optical isolator 150″ is effective regardless of the value of the first polarization angle α, as well as for a variety of different orientation angles ε and predetermined polarization shifts δ.

FIG. 2D shows an optical isolator 150□ that includes half waveplate 155″, a first polarizer 152□, Faraday rotator 154, and second polarizer 156′. The structure and function of optical isolator 150 is generally the same or substantially the same as described with regard to optical isolator 150′ of FIG. 2C. However, the positions of the half waveplate 155″ and first polarizer 152□ are switched. As a result, the polarization angle α of the first polarizer 152□ differs from that of the first polarizer 152 in FIGS. 2A-2C. Also, since the half waveplate 155″ is the first component of the optical isolator 150□ that light from the laser 120 strikes, generally polarized light is received by the optical isolator 150□.

The structure and operation of the Faraday rotator 154 is the same or substantially the same as in FIG. 2A, and the structure and operation of the second polarizer 156′ is the same or substantially the same as in FIG. 2B. The orientation angle δ of the half waveplate 155″ is generally the same as that of the half waveplate 155″ in FIG. 2C. However, the polarization angle α of the first polarizer 152□ generally matches the polarization angle of the light emerging from the half waveplate 155″. Examples of various polarization, rotation and orientation angles α, γ, δ, and ε for the half waveplate 155″, first polarizer 152□, Faraday rotator 154, and second polarizer 156′ in the optical or free space isolator 150□ are shown in Table 4 below (“ε” refers to the difference in the orientation angle of the half waveplate 155′ relative to the polarization angle of the emitted light received by the optical or free space isolator 150═):

TABLE 4
Examples of polarization, rotation and
orientation angles α, γ, δ, and ε in the optical
or free space isolator 150□ (FIG. 2D).

| Example | ε* | α | δ | γ | Pₒᵤₜ |
|---|---|---|---|---|---|
| 31 | 22.5 | 45 | 45 | 90 | 90 |
| 32 | −22.5 | −45 | −45 | −90 | −90 |
| 33 | 67.5 | 135 | −45 | 90 | 90 |
| 34 | 112.5 | 225 | 45 | 270 | 270 |
| 35 | 15 | 30 | 60 | 90 | 90 |
| 36 | −25 | −50 | −40 | −90 | −90 |
| 37 | 30 | 60 | 30 | 90 | 90 |
| 38 | −30 | −60 | 60 | 0 | 0 |
| 39 | 60 | 120 | −30 | 90 | 90 |
| 40 | 22.5 | 45 | −45 | 0 | 0 |

The operation of the optical isolator 150□ is thus substantially the same as that of the optical isolator 150″ of FIG. 2C. Pₒᵤₜ (the polarization angle of light after passing through the optical isolator 150□) is the same as the second polarization angle γ of the second polarizer 156′ (which is the same as the polarization angle of the light after passing through the Faraday rotator 154). In Examples 31-37 and 39, the third polarization angle γ is orthogonal (i.e., different by [2n+1]*90°, where n is an integer, such as −1, 0, 1, etc.) to the polarization angle of the emitted light. Also, Examples 31-34 and 39-40 lead to reflected light having a polarization angle that is orthogonal to the first polarization angle α after passing through the Faraday rotator 154. The optical isolator 150□ is effective regardless of the polarization angle of the emitted light, as well as for a variety of different orientation angles ε and predetermined polarization shifts δ.

For those examples of the optical isolator 150□ where the reflected light has a polarization angle that is not orthogonal to the first polarization angle α after passing through the Faraday rotator 154 (e.g., Examples 35-38), the optical isolator 150□ may be more effective than optical isolators 150-150″ (FIGS. 2A-2C) due to the combined attenuation of the reflected light by the first polarizer (which occurs in all of the exemplary optical isolators) and the non-parallel polarization angle of the reflected light from the half waveplate 155″. For instance, in Example 35, assuming the light reflected towards the optical isolator 150□ has a polarization angle of 90°, the polarization shift δ of 60° from the Faraday rotator 154 gives the reflected light a polarization angle of 150°. The first polarization angle α (30°) of the first polarizer 152□ attenuates the light (e.g., by the absolute value of the cosine of the difference between the polarization angle of the reflected light [150°] and the first polarization angle α [30°], or 50%), then the half waveplate 155″ rotates the attenuated light by (2*[150°−15°])=−270° to an angle of −120°, which is closer to orthogonal than to parallel with respect to the polarized light from the laser 120. Thus, the difference in polarization angles between the emitted light and the reflected light further reduces or minimizes any interference with the emitted light or damage to the laser cavity.

As discussed above, any of the optical isolators 150-150□ can further include an antireflective film or coating on any surface of any component thereof, although there generally will not be two or more antireflective films or coatings between adjacent components of the optical isolator. Also, the components may be adhered together or stacked on each other in any manner known in the art. For example, any component (e.g., the first and second polarizers) may be adhered to one or two other components (e.g., the Faraday isolator and/or half waveplate) using an optically transparent glue, or other attachment mechanism known in the art.

An Exemplary Multichannel Optical or Optoelectronic Transmitter

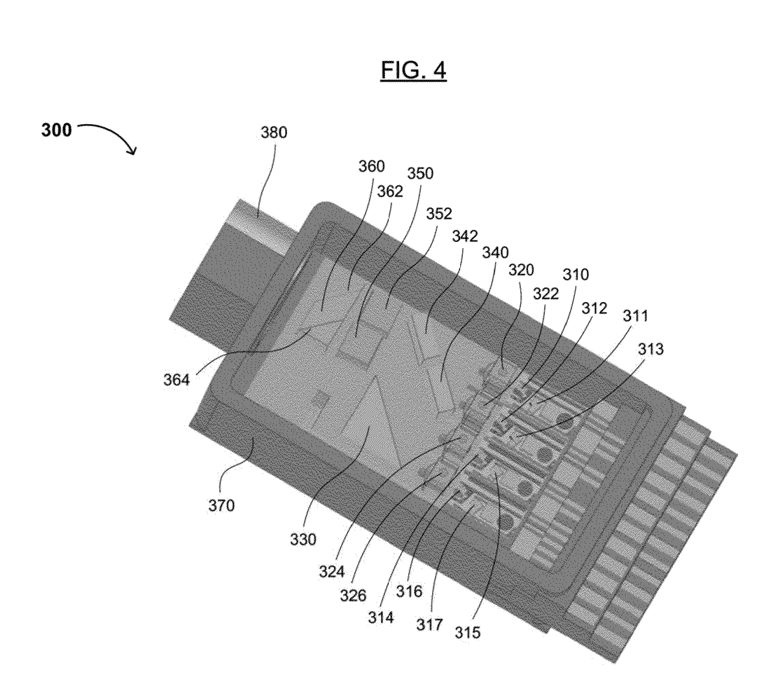

FIG. 4 shows a diagram 300 of an exemplary multichannel optoelectronic transmitter (e.g., a transmitter optical subassembly, or TOSA) in a sealed housing 370 fitted with a connector or coupler 380 for receiving an optical fiber (not shown). The optoelectronic transmitter of FIG. 4 may be a 40G or 100G-compliant optical or optoelectronic transmitter that includes a plurality of light emitters 310, 312, 314, 316 on an optical board. Each light emitter 310, 312, 314, 316 is configured to emit polarized light having a unique and % or characteristic wavelength, polarization type, or combination of wavelength and polarization type.

The present optoelectronic transmitter may be utilized in dense WDM (DWDM) applications. Channels may be defined in a network using DWDM transmissions by the center wavelength and/or polarization type of light emitted by the light emitters 310, 312, 314 and 316. Each of the light emitters 310, 312, 314 and 316 may comprise a laser diode, although any source of polarized light or light pulses may be used (e.g., a pulsed edge- or surface-emitting laser diode, a distributed feedback laser [DFB], an electro-modulated laser [EML], etc.), for the exemplary transmitter 300. Light signals from the light emitters 310, 312, 314 and 316 may be pulsed at a rate of 1 kHz to 25 GHz, or any value or range of values therein. The light emitted by the light emitters 310, 312, 314 and 316 may be polarized, but not necessarily with the same polarization type (e.g., one or more light emitters may emit s-polarized light, while one or more other light emitters may emit p-polarized light). The center wavelengths of light emitted by the light emitters 310, 312, 314 and 316 may be from about 400 nm to about 3000 nm in length, and may have a minimum difference or spacing of about 0.4 nm, 0.8 nm, 4.5 nm, 10 nm, 20 nm, or any other value of at least about 0.4 nm (and up to about 100 nm) from the other center wavelengths of light emitted by the other light emitters. The transmitter 300 as shown in FIG. 4 may also emit and combine collimated light.

Housing 370 can include a housing or package (e.g., a quad [4-channel] small form-factor pluggable [QSFP] package) that encases optical components on the optical platform or board. However, the present multi-channel transmitter may have any number of light emitters (e.g., from 2 to 8 channels or more; see, e.g., U.S. patent application Ser. No. 13/820,989 [Attorney Docket No. SP-224-L], filed on Mar. 5, 2013, the relevant portions of which are incorporated herein by reference), and be housed in any standard or standardized package. The light emitters 310, 312, 314 and 316 can be implemented as integrated circuits or chips, and can include laser diodes and/or light-emitting diodes (LEDs). As such, light emitters may also be referred to as “light emitter chips” or “laser diodes” herein. The light emitter chips 310, 312, 314 and 316 may be passively adhered in place, such as by gluing them onto the circuit board or optical platform in predetermined locations, prior to alignment of the optical components in the transmitter 300 (described below).

The plurality of light emitters 310, 312, 314 and 316 may be coupled to a single optical fiber (e.g., in the connector 380). The connector 380 may include a lens holder (not shown). The lens holder can house an output lens that focuses the light from the transmitter 300 such that the far field spot is at or near the end of the optical fiber. The lens holder may also be coupled to or mounted on the housing or package 370. The housing or package 370 may have a window therein for viewing various components in or of the transmitter 300. In one embodiment, the lens holder is slightly off-center from the end of the transmitter housing, aligned with the optical path of light from one of the center light emitters 312 and 314. In addition, the lens holder may be proximate to an output stage component (e.g., a filter, beam combiner, isolator and/or collimator) for the optical fiber.

In various embodiments, a monitor (e.g., a back-facet monitor) 311, 313, 315 and/or 317 may be associated with each of the light emitters 310, 312, 314 and 316. For example, monitor 311 may monitor or detect light from light emitter 310, monitor 313 may monitor or detect light from light emitter 312, monitor 315 may monitor or detect light from light emitter 314, and monitor 317 may monitor or detect light from light emitter 316. Each monitor may be configured to receive a portion of the light from the corresponding light emitter, and may include a photodiode optically coupled to the back side of the corresponding light emitter or laser diode. The monitor can detect a small part of the light (polarized or unpolarized) emitted from the light emitter, and may transmit a feedback signal (e.g., to a bias controller, not shown). Alternatively, in some embodiments (e.g., not employing a back-facet monitor), the monitor can receive a small amount of the optical signal output by a modulator associated with the corresponding light emitter using a mirror in the optical output path from the light emitter that is substantially transparent to light having the wavelength of the optical signal.

One or more lenses 320, 322, 324, and 326 and one or more filters or beam splitters (e.g., polarization beam filter) 340, 342 are in the optical path of the polarized light emitted by each light emitter 310, 312, 314, 316. Examples of such optical components and alignment thereof are provided in detail in U.S. patent application Ser. No. 14/000,160, filed Aug. 16, 2013 (Attorney Docket No. SP-227-L), the relevant portions of which are incorporated herein by reference. The lenses 320, 322, 324, and 326 focus and/or polarize light from the corresponding light emitters 310, 312, 314 and 316. One or more of the lenses 320, 322, 324, 326 may be pre-assembled or pre-adhered to a corresponding lens holder (not shown). In other or further embodiments, the lenses 320, 322, 324, 326 may be secured (e.g., adhered or epoxied) to the corresponding holder with one or more surface structures that prevent the adhesive (e.g., epoxy) from spreading to neighboring lenses and/or lens holders. Such embodiments allow for independent curing processes to be performed for each lens and/or lens holder.

Filters (or beam splitters) 340 and 342 may be or comprise a polarization filter or beam splitter, configured to allow light of a first polarization type to pass through, while light of other polarization type(s) are reflected, absorbed or scattered. For example, filters 340 and 342 may be transparent to p-polarized light, but reflective of s-polarized light. In such an embodiment, the light signals from light emitters 310 and 312 may be p-polarized, and the light signals from light emitters 314 and 316 may be s-polarized. Thus, in some embodiments, the optical subassembly includes one or more polarization angle-dependent filters configured to filter (or reflect) light having a different polarization angle or polarization type as emitted light, but which may have the same center wavelength. One or more of the beam splitters 340 and 342 can also be or include a 50/50 beam splitter, although there may be some incremental insertion loss when using a 50/50 beam splitter.

Alternatively, filters 340 and 342 may be or comprise a wavelength-selective filter (e.g., a light filter that selectively allows light of a certain wavelength or wavelength range to pass through or to be reflected, while other wavelengths are reflected or passed through, respectively, or absorbed or scattered, as the case may be). Thus, in some embodiments, the optical subassembly includes one or more wavelength-dependent filters configured to filter (or reflect) light having the same polarization angle or polarization type, but a different center wavelength, as emitted light. The reflected light may be reflected along a common optical path. For example, one or both of the filters (e.g., beam splitters) 340 and 342 may include an edge filter, an output coupler 380 or a dichroic mirror that reflects light having a relatively long wavelength, while passing through light having a relatively short wavelength. Alternatively, one or both of the filters or beam splitters 340 and 342 may reflect light having a relatively short wavelength, while passing through light having a relatively long wavelength. In such embodiments, the light signals from light emitters 310 and 314 may have the same polarization type, but different center wavelengths, and the light signals from light emitters 312 and 316 may have the same polarization type (which may be the same as or different from that from light emitters 310 and 314), but different center wavelengths.

One or more mirrors 330 may reflect the light signals from emitters 314 and 316 towards the filters or beam splitters 340 and 342, regardless of the wavelength or polarization type of the signals. Also, to further improve the transmission of an optical signal from light emitters 314 and 316, the single mirror 330 may be replaced by two separate mirrors that separately reflect the light signals from light emitters 314 and 316. In embodiments in which the mirror 330 consists of a single mirror, mirror 330 may be a unitary piece having a single mirrored surface. Although a triangular piece is shown, other two-dimensional shapes when viewed from the top (e.g., square, rectangular) providing a substantially flat mirrored surface for reflecting the light signals from light emitters 314 and 316 are suitable.

In embodiments in which the mirror 330 (which reflects light from both light emitters 314 and 316) includes two mirrors, one mirror generally reflects light from one light emitter 314, while the other independently reflects light from the other light emitter 316. The two mirrors may be mounted on a mirror mount having the same, or approximately the same, size and shape as mirror 330. In such a case, the two mirrors can be mounted and aligned separately and/or independently.

Optical isolators (or free space isolators) 350 and 352 are in the optical path of the polarized light emitted from the light emitters 310, 312, 314 and 316, and are optical components that may allow transmission of light in only one direction. Optical isolators 350 and 352 may prevent unwanted feedback (e.g., reflected light) into the cavity of the light emitters 310, 312, 314 and 316. Optical or free space isolators 350 and 352 may be or comprise any of the optical isolators 150-150□ of FIGS. 2A-D, including first and second polarizers on opposite sides or surfaces of a Faraday rotator, in combination with a half waveplate.

Each of the optical or free space isolators 350 and 352 includes a first surface and a second surface, and the optical or free space isolators 350 and 352 generally receive light having a first polarization angle (e.g., 0°, 45°, 90°, etc.) at the first surface, and rotate the polarization angle of reflected light incident on the second surface (e.g., by about 90°), thereby reducing or avoiding the potential loss of the light intensity or power at the beam splitter or combiner 340/342. In further embodiments, the optical or free space isolators 350 and 352 include a somewhat conventional Faraday isolator (e.g., a Faraday rotator with first and second polarizers on opposite sides or surfaces thereof) and a half waveplate (e.g., 155 in FIGS. 2A-2B, or 155″ in FIGS. 2C-2D). For example, in FIG. 2A, the half waveplate 155 is on the surface of the Faraday isolator facing the optical medium or surfaces that reflect the light, and the half waveplate 155″ in FIG. 2D is on the surface of the Faraday isolator facing the light emitter. The Faraday rotator, first and second polarizers, and half waveplate are generally commercially available, and can be assembled in a conventional manner to form the optical or free space isolator, as shown in FIGS. 2A-2D.

Referring back to FIG. 4, the polarization beam combiner (PBC) 360 may be or comprise a wavelength selective, variable or coherent polarization beam combiner. The PBC 360 may function (generally in reverse, or in a different application) as a polarized light beam splitter. Alternatively or additionally, PBC 360 may comprise a grating or other optical waveguide, such as a wavelength grating router. Furthermore, the PBC 360 may include a first mirror 362 and/or a second mirror 364 to reflect and/or combine the light signals from the optical or free space isolators 350 and 352. Thus, in some embodiments, the PBC 360 (and in particular, the second mirror 364) may reflect light having a first polarization type (e.g., s-polarization) and allow light having a second polarization type (e.g., p-polarization) to pass through. In such embodiments, the beam splitters 340 and 342 may be or comprise wavelength-dependent filters, in which case the light from light emitters 310 and 314 may have the first polarization type, and the light from light emitters 312 and 316 may have the second polarization type. Alternatively, the PBC 360 (and in particular, the second mirror 364) may reflect light having a first center wavelength (or a center wavelength in a first wavelength band or range) and allow light having different wavelengths to pass through. In such embodiments, the beam splitters 340 and 342 may be or comprise polarization filters or beam combiners, in which case the light from light emitters 310 and 312 may have a first polarization type, and the light from light emitters 314 and 316 may have a second polarization type. In general, the first mirror 362 is similar in function and structure to the mirror 330.

The light reflected from the beam combiner 360 and/or an optical medium (not shown) generally travels in an opposite direction to that of the emitted light (e.g., 180° to the emitted light), but light reflected from an object not in the optical path (or from a second lens [not shown] adjacent to the optical medium) may be reflected at an angle other than 180°. If the angle of reflected light is >90° with respect to the emitted light, it can enter the second surface in a direction at least partly opposed to the first direction (i.e., of the emitted light). In any case, the optical or free space isolators 350 and 352 function to attenuate or block light reflected by the beam combiner 360, optical medium and/or other structure (e.g., a focusing lens; not shown), as described elsewhere herein.

The multi-channel optoelectronic device (e.g., optical transmitter or transceiver) generally has a plurality of optical paths or light paths. For example, a first optical or light path is for light emitted from the laser diode 316, passing through lens 326, and reflected by the mirror 330 90° towards the filter 340. The first lens 326 may focus the light in the first optical path onto a location or spot on the surface of the filter 340 from which light emitted by the laser diode 312 exits the filter 340. The filter 340 reflects the light in the first light path through the optical or free space isolator 350 and the PBC 360, toward the optical medium (optionally after further focusing by a second lens and/or collimating with a collimator). As shown in FIG. 4, this first optical or light path has the second greatest length of all the optical or light paths in the multi-channel device 300.

A second optical or light path is for light emitted from the laser diode 312 and passing through lens 324. The lens 324 may focus the light emitted the laser diode 312 onto an end of the optical medium or onto a second lens between the PBC 360 and the optical medium. Filter 340 combines the light from laser diodes 312 and 316 at the same location on the surface of filter 340 facing towards the PCB 360. The combined light goes through the optical or free space isolator 350 and passes through the PBC 360 (e.g., a polarization filter or beam combiner 364 included in the PBC 360). As shown in FIG. 4, this second optical or light path has the smallest length of all the optical or light paths in the multi-channel device 300.

A third light path is for light from the laser diode 310 and passing through lens 320, the second filter 342, and the second optical or free space isolator 352. The lens 320 may focus the emitted light on a location on the surface of the polarization filter/beam combiner 364 where the combined light in the first and second optical paths emerges. The light passing through the second optical or free space isolator 352 along the third optical path is reflected by the mirror 362 of the PBC 360 towards the polarization filter/beam combiner 364, where it is reflected again towards the optical medium and/or a lens between the PBC 360 and the optical medium. As shown in FIG. 4, this third optical or light path has the second smallest length of all the optical or light paths in the multi-channel device 300.

A fourth light path is for light from the laser diode 314, passing through lens 324 and reflected by the mirror 330. The lens 324 may focus the emitted light on the location or spot on the surface of the filter 342 facing towards PBC 360 where light from the laser diode 310 emerges. The filter 342 reflects the light in the fourth optical or light path 90X) towards the optical or free space isolator 352. Thus, the filter 342 combines the light emitted from laser diodes 310 and 314. At this point, the fourth optical path is essentially the same as the third optical path (i.e., the light passing through the second optical or free space isolator 352 is reflected by the mirror 362 of the PBC 360 towards the polarization filter/beam combiner 364, where it is reflected again towards the optical medium and/or a lens between the PBC 360 and the optical medium). At the filter/beam combiner 364 of the PCB 360, all light beams are combined, and exit the TOSA along a single path. As shown in FIG. 4, this fourth optical or light path has the greatest length of all the optical or light paths in the multi-channel device 300.

Exemplary embodiments of the present multi-channel transmitter include a first optical component (e.g., a lens, mirror, filter or beam combiner) configured to focus or reflect light from a corresponding one of the light emitters 310, 312, 314, 316, and a second optical component configured to focus or reflect light from a second one of the light emitters 310, 312, 314, 316. The second optical component may independently be (or comprise) a lens, mirror, filter or beam combiner. The optical subassembly may further include a third optical component (e.g., a filter or beam combiner), configured to combine light from at least two of the light emitters 310, 312, 314, 316, an optional fourth optical component (e.g., a mirror) configured to reflect light passing through one or more of the other optical components towards a remaining one or more of the other optical components (or towards a fifth optical component), and a structural support on which the first, second, third and optional fourth optical components are deposited, fixed or mounted. The third optical component may include a dichroic mirror or polarization filter (e.g., 340 and/or 342 in FIG. 4). The present transmitter may include first through fourth light emitters, in which case the first optical component comprises a first lens configured to focus light from the first light emitter, the second optical component comprises a first mirror configured to reflect light from the second light emitter, and the transmitter further comprises fourth and fifth optical components, each configured to reflect and/or combine light from the third and fourth light emitters. Such a multi-channel transmitter may further comprise second through fourth lenses, configured to focus light from the second through fourth light emitters, respectively.

The emitted light is received by the optical or free space isolator (e.g., 350 and/or 352) after the light passes through the first, second, third and optional fourth optical components.

In further embodiments, the optical medium receives the polarized light from the combined optical paths. The optical medium may be an optical fiber that receives rotated, polarized light from the free space isolator(s) 350 and/or 352. Light may reflected by the optical medium (and/or a lens between the optical medium and a final beam combiner). In embodiments in which light having two or more polarization types is emitted, light of a first polarization type may be reflected and rotated by the optical or free space isolator(s) in a manner that result in the reflected light having the second polarization type, and passing into a cavity of a laser emitting light of the second polarization type. In this case, damage to the laser emitting light of the second polarization type may be expected. However, selection of filters, beam combiners, optical or free space isolators and possibly other components in the multi-channel device can avoid such damage by rotating, filtering, attenuating and/or blocking the reflected light in a way that eliminates the reflected light from reaching the laser or that ensures that only a small amount of reflected light having a very different polarization angle than the emitted light can reach the laser cavity.

Exemplary Methods of Forming an Optical Signal in a Single-Channel or Multichannel Optical or Optoelectronic Transmitter

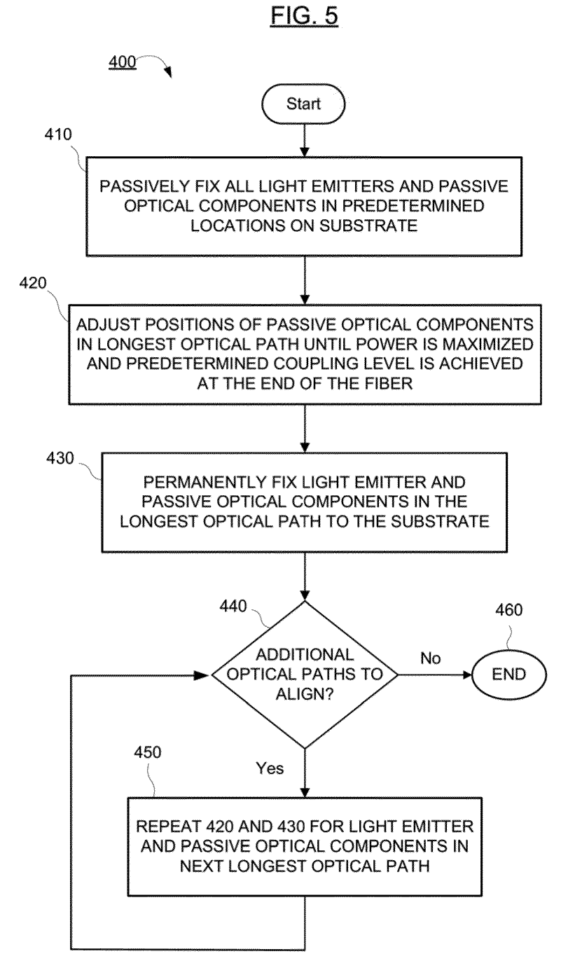

FIG. 5 shows a flow chart 400 illustrating an exemplary method of making an optical or optoelectronic transmitter, configured to transmit one or more optical signals in accordance with embodiments of the present invention. At 410, all light emitters are passively adhered (e.g., placed, secured, affixed, mounted or attached) in predetermined locations on a substrate (e.g., optical board). In addition, all passive optical components are passively adhered in predetermined locations on the substrate (optical board). In the described examples, four light emitters are used, but the number can be more (e.g., 6, 8, 10, 12, 16 or more) or less (e.g., 2 or 3). In general, one light emitter is placed in a location along a straight line with the input to (e.g., an optical axis of) an optical transmission medium, such as an optical fiber, and any output lens and/or collimator along the straight line, adjacent to a connector for the optical fiber. In one embodiment, the remaining light emitters are placed on the optical board on adjacent sides of the optical axis between the first light emitter and the optical transmission medium. Alternatively, the remaining light emitters are placed on the optical board on adjacent sides of the first light emitter, such that the initial optical paths from each of the light emitters are parallel. The light emitters may be placed on the optical board in any sequence.

The light emitters (e.g., light emitter chips) may be passively adhered in place, such as with an uncured adhesive. Also, positioning tools (see, e.g., forceps or tweezers) may be utilized for temporarily placing, grasping and/or clamping the light emitters and/or adjusting the positions of the light emitters (and eventually, other optical components, such as filters, beam splitters, isolators, lenses, etc.). However, light emitters are typically placed on the optical board using automated placing equipment. The light emitters are also generally wire-bonded to metal traces on the optical board that control the light signal output by each light emitter (e.g., on/off switching, power, bias, etc.). Alternatively, after aligning all components in the optical path between the first light emitter to be aligned and the optical transmission medium, the remaining light emitters may be placed and wire-bonded. In addition, an output collimator may be passively fixed on the optical board or optical platform near the output (e.g., second) lens holder, adjacent to the connector.

At 420, positions of the passive optical components in the longest optical path (e.g., from laser diode 314 in FIG. 4) are adjusted until the optical power is maximized and/or a predetermined coupling level is achieved at the end of the optical medium (e.g., the fiber connected to the connector or coupler 380 in FIG. 4). The passive optical components involved in alignment may include an output collimator, one or more lenses (generally corresponding to a unique light emitter), a plurality of beam splitters or other light filters, a plurality of isolators (e.g., optical or free space isolators), and/or one or more mirrors. Referring to the example of FIG. 4, the first light emitter 314, lens 324, mirror 330, beam splitter 342, optical or free space isolator 352, and PBC 360 are passively fixed and aligned.

The steps of passively fixing remaining passive optical components onto the optical board and connecting the optical fiber may be performed in any order or sequence. In various embodiments, passively fixing the remaining optical components can include adhering the optical component(s) onto a circuit board or optical platform in predetermined locations. The various optical components may be placed into a housing that partially or fully encloses and protects the components as they are being placed and aligned on the optical board. The housing is generally pre-formed, and may include a molded plastic housing, a stamped metal housing with an insulating liner therein or thereon, etc., configured to enable placement of the various optical components in the housing. At the end of the manufacturing process, the open end or open side of the housing may be sealed with a further component of the housing (e.g., the missing end or side, the fiber connector and output lens housing, etc.).

It may not be necessary to place certain components in the TOSA housing in a particular order. However, it may be beneficial to place the passive optical components in their locations temporarily (e.g., using a curable, but uncured, adhesive), adjust the locations during optical signal alignment (e.g., as described herein), then permanently fix the final, aligned locations of the components by curing the adhesive (e.g., using UV irradiation).

Referring back to FIG. 5, at 430, after the optical power is maximized and/or a predetermined coupling level is achieved at the end of the optical medium, the first light emitter and the passive optical components in the longest optical path are permanently fixed to the optical board. Typically, the first light emitter and the passive optical components in the longest optical path are permanently fixed to the optical board by curing (e.g., irradiating) the adhesive with one or more doses of ultraviolet light sufficient to permanently fix or secure the light emitter and the passive optical components to the substrate (optical board).

At 440, it is determined whether there are light emitters and optical components in additional optical paths to align and/or adjust. If a light emitter and optical components in one or more additional optical paths need to be aligned or adjusted (e.g., to maximize the optical power and/or achieve a predetermined coupling level at the end of the optical medium), the method proceeds to 450, where steps 410-430 are repeated for the passively adhered light emitter and optical components in the next longest optical path is achieved 450. For example, referring to the example of FIG. 4, the light emitter 316, lens 326, beam splitter 340, and optical or free space isolator 350 are aligned are aligned with the optical fiber as described above and permanently fixed to the optical board. However, some components in the second optical path (e.g., mirror 330, PBC 360) may already be permanently fixed to the board, so the alignment and/or adjustment of the light emitter and optical components in the second longest optical path may be iterative or repeated until the optical power of the light from the second light emitter (e.g., 316) is maximized and/or a predetermined coupling level is achieved at the end of the optical medium.

As shown in FIG. 5, the alignment process is then repeated for the components in any remaining optical paths. For example, with regard to the example in FIG. 4, light emitter 310 and lens 320 in the third optical path, then light emitter 312 and lens 322 in the fourth optical path, are aligned with the optical medium. Alternatively, if the various optical components in a given optical path are already aligned but not yet permanently fixed to the optical board, the components in the given optical path may be further aligned after alignment of components in a subsequent optical path to improve the alignment of light from each of the light emitters prior to permanently fixing the optical components to the optical board.

Referring back to FIG. 5, when all of the light emitters and optical components in all of the optical paths are aligned, then the method of making the transmitter is complete and stops at 460.

### CONCLUSION

Embodiments of the present invention advantageously provide an optical isolator, a single- or multi-channel optical or optoelectronic transmitter or transceiver configured to transmit light having standard center wavelengths and polarization types or angles, and methods of transmitting an optical signal and of making the transmitter or transceiver, that change the polarization direction of reflected light relative (e.g., perpendicular) to the polarization direction of emitted light, reducing interference between emitted and reflected light, and protecting the laser from damage as a result of the reflected light. Further multi-channel embodiments of the present invention further filter, scatter, reflect or remove reflected light that may have the same or similar polarization as the emitted light, to further protect the lasers in such multi-channel embodiments. The present invention enables transmission of strong and/or coherent polarized light signals, and prolongs the operational lifetime of single- and multi-channel optical transmitters configured to transmit light having standard center wavelengths and polarization types or angles.

The foregoing descriptions of specific embodiments of the present invention have been presented for purposes of illustration and description. They are not intended to be exhaustive or to limit the invention to the precise forms disclosed, and obviously many modifications and variations are possible in light of the above teachings. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. An optical or free space isolator, comprising:
a) a first polarizer, configured to polarize light at a first polarization angle α and block light at a second polarization angle β;
b) a Faraday rotator, configured to rotate the light polarized by the first polarizer by δ degrees, where δ is a predetermined number;
c) a second polarizer in a light path passing through the first polarizer and the Faraday rotator, on a side of or surface of the Faraday rotator opposite from the first polarizer, configured to polarize light at a third polarization angle γ; and
d) a half waveplate in the light path, having a fixed or predetermined orientation angle ε,
wherein α, δ and ε have values that allow light to pass through the optical isolator in a first direction, and block reflected light traveling through the optical isolator along a second direction opposite to the first direction.

2. The optical isolator of claim 1, wherein the second polarization angle β is orthogonal to the first polarization angle α.

3. The optical isolator of claim 2, wherein δ+[2*(ε−[α+δ]) is about (2n+1)*90°, n is an integer, and light passing through the optical isolator in the first direction has a polarization angle that is orthogonal to the first polarization angle α.

4. The optical isolator of claim 3, wherein δ is about ±(β−α)/2, and a is about [(β−α)−δ]/4.

5. The optical isolator of claim 2, wherein δ+[2*(ε−[α+δ]) is about q*180°, q is an integer, and light passing through the optical isolator in the first direction has a polarization angle that is parallel to the first polarization angle α.

6. An optical or optoelectronic transmitter, comprising:
a) a light emitter on an optical board, configured to emit light;
b) one or more lenses in an optical path of said light;
c) the optical or free space isolator of claim 1, in the optical path of said light and providing a polarized light beam or signal having a predetermined polarization angle; and
d) an optical medium in the optical path of the polarized light beam or signal, receiving the polarized light beam or signal from the optical or free space isolator.

7. The transmitter of claim 6, further comprising an optical subassembly comprising:
a) a first optical component configured to focus or reflect light from the light emitter, and
b) one or more structural supports on which the light emitter, the first optical component, the one or more lenses and the optical or free space isolator are deposited, fixed or mounted.

8. The transmitter of claim 6, wherein the optical medium comprises an optical fiber.

9. The transmitter of claim 6, wherein the one or more lenses comprises a first lens and a second lens, the first lens is adjacent to the light emitter, and the second lens is adjacent to the optical medium.

10. The transmitter of claim 9, wherein light is reflected by the second lens and/or the optical medium.

11. The transmitter of claim 10, wherein the optical or free space isolator is configured to pass light from the light emitter to the optical medium, and block the light reflected by the optical medium and/or the second lens.

12. A multichannel optical or optoelectronic transmitter, comprising:
a) a plurality of light emitters on an optical board, each light emitter configured to emit light having a unique wavelength and/or predetermined polarization type;
b) one or more lenses in an optical path of said light from each light emitter;
c) an optical or free space isolator in the optical path of said light from each light emitter and providing a polarized light beam or signal having a predetermined polarization angle, comprising a Faraday rotator configured to rotate polarized light polarized light by a predetermined number of degrees, first and second polarizers on opposite sides of the Faraday rotator along the optical path, and a half waveplate in the optical path having a fixed or predetermined orientation angle, wherein the first polarizer is configured to polarize light at a polarization angle and block light at a second polarization angle; and
d) an optical medium in the optical path of said polarized light beam or signal, receiving the polarized light beam or signal from the optical or free space isolator.

13. The transmitter of claim 12, further comprising an optical subassembly comprising:
a) a first optical component configured to focus or reflect light from a first one of the light emitters;
b) a second optical component configured to focus or reflect light from a second one of the light emitters;
c) a third optical component configured to combine light from at least two of the light emitters, and
d) one or more structural supports on which the first, second and third optical components and the optical or free space isolator are deposited, fixed or mounted.

14. The transmitter of claim 13, wherein the third optical component comprises a dichroic mirror or polarization filter.

15. The transmitter of claim 14, wherein:
a) the plurality of light emitters comprises first through fourth light emitters;
b) the first optical component comprises a first lens configured to focus light from the first light emitter;
c) the second optical component comprises a first mirror configured to reflect light from the second light emitter;
d) the transmitter further comprises fourth and fifth optical components, each configured to reflect and/or combine light from the third and fourth light emitters;

16. The transmitter of claim 15, further comprising second through fourth lenses, configured to focus light from the second through fourth light emitters, respectively.

17. A method of transmitting a polarized optical signal, comprising:
a) emitting light from a light emitter;
b) passing the light through an optical or free space isolator in a first direction to provide the polarized optical signal, the optical or free space isolator comprising a Faraday rotator configured to rotates polarized light by a predetermined number of degrees, first and second polarizers on opposite sides of the Faraday rotator along the optical path, and a half waveplate in the optical path having a fixed or predetermined orientation angle, wherein the first polarizer is configured to polarize light at a first polarization angle and block light at a second polarization angle; and
c) blocking any light reflected back on the optical or free space isolator along a second direction opposite to the first direction.

18. The method of claim 17, further comprising passing the light through a first lens before passing the light through the optical or free space isolator.

19. The method of claim 18, further comprising passing the polarized light through a second lens after passing the light through the optical or free space isolator.

20. The method of claim 17, further comprising directing or focusing the polarized light onto an optical medium.
